(19) United States
(12) Patent Application Publication
(10) Pub. No.: US 2018/0071848 A1
(43) Pub. Date: Mar. 15, 2018

(54) Laser Beam Joining Method and Laser Machining Optics

(71) Applicant: Scansonic MI GmbH, Berlin (DE)

(72) Inventor: Steffen Walter, Berlin (DE)

(21) Appl. No.: 15/558,206

(22) PCT Filed: Feb. 29, 2016
(86) PCT No.: PCT/DE2016/100088

§ 371 Date: Sep. 14, 2017

(30) Foreign Application Priority Data
Mar. 24, 2015 (DE) 10 2015 104 411.0

(51) Int. Cl. B23K 1/005; B23K 26/067; B23K 26/073; B23K 26/06

(52) U.S. Cl. CPC B23K 1/0056; B23K 26/0676; B23K 26/0648; B23K 26/0643; B23K 26/073

(57) ABSTRACT

The invention relates to a method for joining workpieces (12, 13) using a laser beam (7), wherein the laser beam (7) is focused onto a focal plane downstream of the machining plane in the beam propagation direction and subdivided into a plurality of partial beams (19) by means of a beam dividing device (6). The subdivision is effected in a geometric manner, i.e. the partial beam cross sections emerge from a division of the geometric form of the beam cross section of the laser beam (7). The partial beams (19) are guided onto the machining plane (8) in a crossed manner and with an offset from one another in such a way that an extended laser focus (18) is formed. The radiation intensity distribution of the superposed partial beams (19) in the machining plane (8) along a line perpendicular to the seam joint respectively has a maximum at the end regions thereof. As a result thereof and as a result of the spatially extended region of high radiation intensity on both sides along the seam joint compared to the prior art, there is, firstly, an improvement in the edge connection and hence in the quality of the seam joint and, secondly, an increase in the process efficiency.

### CROSS REFERENCE TO RELATED APPLICATIONS

This application is the U.S. national stage of International Application No. PCT/DE2016/100088, filed on 2016 Feb. 29. The international application claims the priority of DE 102015104411.0 filed on 2015 Mar. 24; all applications are incorporated by reference herein in their entirety.

### BACKGROUND

The invention relates to a method and a laser machining optics for joining workpieces using a laser beam. By means of the method, firstly, an improvement in the edge connection and hence in the quality of the seam joint and, secondly, an increase in the process efficiency is rendered possible.

Both, laser welding and laser soldering are known for joining two workpieces using a laser beam. In both cases, the workpieces are joined at a joint by fusing of material. Whereas during laser welding the workpieces themselves, and their surfaces, respectively, are molten, during laser soldering merely a soldering wire brought upon or into the the joint is being melted.

Laser beam welding, however, may be performed using a filler wire, e. g. when the gap at the joint is large. The filler wire is positioned into or onto the gap of the joint; the laser beam is melting the two workpieces at their border regions located at the joint as well as the filler wire, as a result of which a melt pool is formed.

The power input during joining two workpieces using a laser beam is characterized by a spatial radiation intensity distribution, and thus an energy distribution, of the laser focus (also called laser spot) in the machining plane. For example, in the case of a butt joint the machining plane usually is located at the joint on the surface of the two workpieces to be joined. Frequently, laser spots with either a rotationally symmetrical rectangular or Gauss-shaped profile of their radiation intensity distribution in the cross-section are being used. However, as described below, rectangular or line-shaped focusing optics are known, too, which create a non-rotationally symmetrical laser spot. The energy distribution along a line in the cross-section of the laser spot essentially follows a rectangular profile or a Gaussian distribution, i. e., the energy distribution along this line essentially is homogeneous or exhibits a maximum at the center of the laser spot, respectively.

However, in laser beam welding using a filler wire, such an energy distribution is unfavorable since the greater part of the laser light intensity impinges on the filler wire and only a small part impinges on the workpieces to be joined. On the one hand, low-melting alloys usually are used as a filler wire, as a result of which a low amount of energy suffices for fusing in comparison to fusing the workpieces. On the other hand, part of the laser power impinging on the filler wire is reflected and thus wasted.

To overcome this undesirable effect, for example two laser beams for joining or two laser spots can be used in the machining plane.

DE 10 2011 016 579 A1 shows a method and a device for laser beam welding using two laser beams of differing power density, wherein the laser foci are arranged one after another with respect to the feed direction. For this purpose, two separate lasers or a laser, the laser beam of which is split, can be used.

WO 98/51442 describes a device for welding using two laser foci, wherein two, parallel and in a variable distance to each other running partial laser beams are created from one laser beam by use of mirrors. Here, the laser foci are arranged along a line perpendicular to the weld seam, i. e. each of the two partial laser beams is directed onto a dedicated workpiece.

DE 199 61 918 C2 refers to a method and a device for subdividing a laser beam using a variable lens system to create at least two laser foci on a workpiece to be machined, wherein the distance and the intensity of the laser foci can be varied continuously. Here, the laser foci are arranged preferably along a line running perpendicular to the weld seam. By use of a turning device the arrangement of the laser foci may be varied at will with respect to the weld seam. DE 101 13 471 A1 discloses a method for hybrid welding using a laser double focus.

DE 102 61 422 B4 shows a laser welding and soldering method as well as an corresponding device in which a laser beam is divided into at least two separately focusable partial laser beams of different intensity by means of a variable optical arrangement with a prism and a lens system, wherein the partial laser beams are divided with respect to their power distribution, focal position rotation with respect to the joint and/or to their working point distance, so that two separate laser foci can be used for joining. In this case, a first partial beam is focused onto the processing plane while a second is focused onto a focusing plane located above the processing plane so that within the processing plane this second partial beam is expanded and has a lower energy density than the first partial beam.

By use of the device for welding as disclosed in JP H07-60 470 A a splitting of a laser beam into two partial beams is provided, wherein the separated partial beams are used for simultaneous welding of a workpiece at different positions in order to reduce thermally induced stresses.

More techniques for generation of two partial laser beams as well as their application are disclosed in DE 196 19 339 A1, WO 95/11101 A1, DE 197 51 195 C1 and DE 43 16 829 A1, wherein these techniques allow only for limited adaptability to the requirements of a material machining process and these adaptations may be realized with great efforts only, respectively.

It is common to the described methods or devices that in each case at least two separate laser spots are used for processing, the radiation intensity distribution in the laser beam or laser beams being either the typical Gaussian profile or, when e.g. a fiber end is mapped, has a homogeneous, rectangular intensity distribution (also called tophat) along a line through the respective cross-section of the laser spots.

In EP 1 525 972 A2 a method for laser beam welding is specified, in which a laser beam is split into two partial beams, wherein the partial beams are used for welding either separately or superimposed. A targeted design of the overall intensity distribution of the superimposed partial beams is not disclosed herein.

The expansion of the laser spot to cover a rectangular area in the processing plane is also known. DD 229 332 A1 shows an apparatus, which focuses or defocuses a laser beam with a circular cross-section and Gaussian radiation intensity distribution onto a rectangular area on the weld seam region by means of one or two cylindrical lenses. However, even in this method, the laser fosuc shows the maximum of the radiation intensity in its center which is used for joining actually. The less pronounced radiation intensity at the edges of the focus is used for pre- or postheating of the joined region of the workpiece.

A method for modification of the radiation intensity distribution in a single laser beam is shown in DE 40 34 744 C2. Here, a subdivision of a laser beam into two partial beams takes place first, then a modification of the properties of one of the partial beams is done and finally the two partial beams are merged into a total beam. This method also permits to modify the radiation intensity distribution in the composite laser beam in such a way that two Gaussian profiles, each having different parameters, are combined to an overall profile, the respective maxima of the individual Gaussian profiles being located at the same spatial position. Thus, the composite laser spot is also characterized by a light intensity which decreases towards the edge.

The Powell lens, named after its inventor and described in detail in U.S. Pat. No. 4,826,299 A, is also known to the person skilled in the art for producing a linear laser spot, the intensity distribution along the line being largely constant. This is achieved by transformation of the laser beam in the direction of this line by means of prism-shaped lenses. Perpendicular to the line, the laser beam is focused on the processing plane.

WO 2014/052239 A1 discloses a device making use of a Powell lens, by means of which the energy distribution along the projected line-shaped laser spot is made even more homogeneous. Perpendicular to this line, however, the Gaussian intensity profile remains, i.e. the energy density distribution across the line cross section, i.e. perpendicular to the line, exhibits a maximum in the center, whereas it decreases continuously towards the edges.

A further limitation of the Powell lens is that the line width of the laser spot, i. e. the extension of the line-shaped laser spot transversely to the line, is fixedly determined by the beam cross section of the laser beam injected. The effective spot width is also predefined by the wedge angle used, the radiation intensity being identical at the weld seam and the edges of the weld seam. An increase in the integral energy input into the workpieces adjacent to the seam would be possible only by an extension of the laser spot line, but the area affected by the energy input is also increased—with a simultaneous reduction in the energy density.

It would be desirable to have a laser joining method in which the geometrical shape of the laser spot and its energy distribution in the machining plane can be modified in such a way that only one laser spot and a very simple optical design is required for joining, wherein the energy density in the edge region of the laser spot—preferably directly next to the joint, i.e. at the flanks of the seam—is highest.

### SUMMARY

The object of the invention consists in improving the edge connection and hence the quality of the joint during laser beam joining by use of a—compared to the state of the art—more effective (as well as within certain limits definable) distribution of the radiation intensity within the focus with the formation of sharper focus outer edges on the workpieces to be joined or the weld seam, wherein at the same time the energy balance of the laser beam joining process, in particular in the case of laser beam welding with additional wire, shall be improved by increasing the energy input into the joining partners compared to the energy input at the position of the joint. Furthermore, the spatial extension of the focus within the machining plane shall be adjustable along the joint, wherein the area of high energy density of the laser focus acting upon the joining partners shall exhibit a length, particularly at the flanks of the seam with respect to the feed direction, equaling the extension of the laser focus in this direction.

### DETAILED DESCRIPTION

With respect to the method this object is achieved, in accordance with the invention, by a method with the features of claim 1. With respect to the laser machining optics this object is achieved, in accordance with the invention, by a laser machining optics with the features of claim 5. Advantageous configurations of the invention are the subject-matter of dependent claims.

In accordance with the invention, a more effective distribution of the radiation intensity in the laser focus (with formation of sharper focus outer edges compared to the prior art) in a machining plane on the workpieces to be joined or the weld seam during laser beam joining is carried out by a modification of the laser focus geometry as well as the radiation intensity distribution in the cross section of the defocused laser beam in the machining plane. These modifications of the laser beam are achieved by a geometric subdivision of the laser beam into partial beams, a deflection of the radiation directions of the partial beams with respect to each other and a local as well as orientation-exact merging of the partial beams in the machining plane, wherein a laser focus combined from partial beams is formed within the machining plane, showing a radiation intensity distribution being defined by the subdivision and the deflection.

Preferably, the defocusing of the laser beam is done in a way that the laser focus is used in the so-called far field, i.e. the distance between machining plane and focus is larger, preferably very much larger, than the Rayleigh length of the laser beam, wherein the focus is located downstream of the machining plane in the beam propagation direction. In this case, the radiation intensity distribution (of the undivided laser beam) in the machining plane exhibits a Gauss-shaped profile.

By geometrical subdivision of the laser beam is meant the following method: The laser beam, exhibiting a geometric shape of the beam cross section in a plane normal to the beam, is being subdivided by cutting the cross section such that the partial beams resulting from the subdivision show a geometric shape of their cross section, which is a fraction (i.e. part) of the geometric shape of the cross section of the undivided laser beam, wherein the geometric shape of the (undivided) beam cross section can be formed by combining in a plane all partial beam cross sections created by the subdivision.

For example, by preferably centrally subdividing a circular beam cross section once along the direction of division, two partial beams are produced in this manner, the partial beam cross sections of which have the geometric shape of a semicircle each. In the case of a Gaussian radiation intensity distribution across the beam cross section of the undivided laser beam, both partial beams also exhibit in their partial beam cross section along the direction of division a Gaussian radiation intensity distribution. Perpendicular to the direction of division, the radiation intensity distribution in a partial beam cross-section in the far field has a profile which corresponds to a Gaussian curve which is cut off in the maximum. Thus, the two partial beams show in the partial beam cross-section transversely to the division line of the circular laser beam cross-section a distribution of the radiation intensity, which increases monotonously from zero to a maximum value with asymmetrical and mirror-image position of the maximum. The distance between the cutting edges of the cut-off Gaussian curves transversely to the direction of division, that is, in the direction of the beam offset in the machining plane, is referred to hereinafter as “beam offset”.

According to the invention, the geometric division of the defocused laser beam preferably is performed in the manner described above, that is, the (circular) cross section of the laser beam is subdivided along one or a multitude of chords (which preferably are running in the vicinity of the laser beam axis) into partial beams each of these having a partial beam cross section like e.g. segments of a circle. In a partial beam, the radiation intensity (in the far field) increases along a direction in the partial beam cross section (which is perpendicular to the dividing line) monotonically from a minimum value at a first outer edge of the partial beam cross section to a maximum value at the second outer edge, which is lying vis-à-vis the first outer edge of the partial beam cross section.

An individual distribution of the laser power between the individual partial beams is possible by positioning the chord or chords, respectively, which subdivide the laser beam, within the laser cross section.

The superposition of the partial beams in the machining plane then is performed in such a way that the partial beams impinge on the machining plane with a spatial offset of their beam axis with respect to each other, wherein the extended laser focus formed by the superposition of the partial beams in the machining plane preferably is a superposition of circular segments and shows a rectangular envelope.

The sum profile of the radiation intensities of the superposed partial beams in the machining plane along a line, which is defined by the offset of the beam axes of two partial beams in the machining plane, has a first maximum at a first end region of the laser focus, a minimum located between both end regions and a second maximum at a second end region opposite the first end region of the laser focus.

The first maximum value of the radiation intensity, i.e. light intensity, may be identical to the second maximum value. The minimum value of the radiation intensity depends on the offset of the two superposed partial beams as well as on the defocusing of the undivided laser beam.

According to an embodiment of the invention the offset of the partial beams in the machining plane is selected such that the spatial extension of the laser focus formed by the combination of the partial beams in the machining plane in the direction defined by the offset of the two partial beams essentially matches the diameter of a laser spot, which would be created by the undivided laser when impinging on the machining plane. In this case—with a Gaussian radiation intensity distribution present in the undivided, defocused laser beam—the above named minimum value of the radiation intensity in the center of the laser focus formed by the partial beams becomes nearly zero and is restricted to a single point in the radiation density distribution. According to the invention, the beam offset should be between 30% and 100%, preferably 50% to 80%, of the beam diameter which the undivided laser beam would exhibit in the machining plane.

In case the beam offset between the partial beams in the machining plane is chosen to be larger than the diameter of the (undivided) laser beam in the machining plane, an (extended) region with the minimum value of approx. zero is formed in the radiation intensity distribution of the laser focus composed of the partial beams—sort of a gap appears in the intensity profile.

With a beam offset less than the diameter in the machining plane and larger than the radius of the (undivided) laser beam a radiation intensity distribution of the laser focus in the machining plane along a direction defined by the offset of the two partial beams with a minimum value of the intensity greater than zero arises.

Preferably, the geometric beam division (e.g. by use of a roof plate or a segmented mirror or a lens, which contains a wedge angle in beam-splitting zones) is carried out by application of a deflection angle perpendicular to the feed direction, such that the partial beams are deflected with respect to the original laser beam axis (and crossing each other in the further course) in a way that the points of incidence of the respective partial beams, i.e. the beam offset in the machining plane, shows an optimum distance favorable for the joining task.

The laser focus formed according to the laser beam joining method inherent to the method normally comprises a rectangular shaped envelope. In the case of a (single) geometrical division of the laser beam along a line (i.e., chord in the circular beam cross-section) parallel to the feed direction, a region of high light intensity, which in comparison to an undivided laser beam accordingly shows a longer extension in the feed direction, is formed to the left and to the right of the weld seam. Thus, a laser focus is created exhibiting quite sharp and long edges extending along the machining direction (direction of welding/soldering) having a high radiation intensity.

According to the invention it is provided to geometrically subdivide the laser beam at least once, wherein two partial beams are formed by geometrically dividing a (partial) beam, i.e. with each geometric division two partial beams are formed from the laser beam or a partial beam. Therefore, it is also provided to geometrically subdivide the laser beam multiple times. For example, four partial beams may be created in this manner, which are combined in such a way that an essentially rectangular shaped laser focus is formed in the machining plane, the radiation intensity distribution of said laser focus exhibiting maxima in each of the four corners of the rectangle.

Preferably, the geometric division is performed such that the light intensity of the (combined) laser focus in the machining plane shows intensity maxima in the two regions of the laser focus located next to the weld seam and a filler wire positioned adjacent to the weld seam, respectively, wherein the absolute minimum of the intensity distribution of the laser focus is projected onto the joint.

The advantage of the laser beam joining method for example is the possibility of increasing the light intensity and thus the energy density at both edge regions of the weld seam extending along the joint, said weld seam being formed during laser welding of two workpieces at a joint using a filler wire. Thus, a lower laser power impinges on the filler wire as compared to the power impinging adjacent to the filler wire on the surfaces of the two workpieces, wherein two regions of high radiation intensity at the flanks of the seam extending along the feed direction are formed. Hence, the energy balance is improved by means of the invention, wherein only one laser focus is applied.

By operating using the far field, wherein the focal point is located below the machining plane, the laser focus—in contrast to beam-dividing variants according to the prior art—exhibits at its outer edges, in particular along the seam, a relatively straight boundary.

The increase in the intensity at the edges of the weld seam in conjunction with the in the feed direction—compared to a laser focus according to the prior art—increased length of influence of the laser focus also improves the edge connection and therefore the quality of the seam joint.

Another advantage of the laser beam joining method according to the invention is the temperature distribution effected by the special areal energy input in the melt pool, which allows for a better degassing of the melt and thus a reduced number of pores in the solidified weld seam as well as a reduced roughness of the weld seam as compared to the prior art.

The laser beam joining method according to the invention may be applied using stationary laser machining optics as well as scanning laser machining systems or systems with integrated seam guidance.

Preferably, multimode laser radiation is used to carry out the method, which e.g. may be generated using fiber coupling of multi-kilowatt-laser, since diffraction pattern occurring in laser radiation in the vicinity of the base mode impair the desired intensity distributions.

In order to apply the laser beam joining method according to the invention a laser machining optics as described below for application in a laser joining apparatus is provided.

The laser machining optics comprises a collimation device, a focusing device and a beam dividing device, all of which are arranged along an optical axis. The beam dividing device may comprise one or more beam-dividing elements.

Along the beam path of the laser beam, first the collimation device, then the focusing device and finally the beam dividing device may be arranged. It also may be provided to arrange the beam dividing device within the beam path of the laser beam between the collimation device and the focusing device. Lastly it is possible to arrange the beam dividing device within the beam path of the laser beam in front of the collimation device and the focusing device.

In case the beam dividing device comprises several, distinct elements, these discrete elements may be arranged separated from each other within the beam path according to above specified positions.

The beam dividing device may be set up using transmitting elements, like e.g. a wedge plate or a roof plate (i.e. a wedge plate exhibiting two wedge segments), or using reflecting elements, like e.g. segmented mirrors (i.e. mirrors, the reflecting surface of which is subdivided into individual segments, wherein the normal vectors onto the surfaces of the segments are tilted by an angle with respect to each other).

The laser machining optics further may comprise one or several cylindrical lenses, which allow for a scaling of the geometric dimensions and the geometric shape, respectively, of the laser focus formed in the machining plane. For example, it may be provided to achieve an elongated rectangular shape of the laser focus using an appropriate combination of convex and concave cylindrical lenses, wherein the extension of the laser focus parallel to the feed direction is much larger than its extension perpendicular to the feed direction.

The beam dividing device further may be equipped with an acylindrical transition zone, which enables a selective splitting of the laser intensity into the individual partial beams in that a part of the laser radiation is deflected differently depending on the point of impact.

Furthermore, it may be provided to combine the beam dividing device and the focusing device into a single optical element. For this purpose, this optical element can, for example, have a focussing boundary surface between two optical media (e.g. air and glass) which is subdivided into segments. Each of the segments of the boundary surface has a normal vector to the surface. The normal vectors of neighboring segments are tilted by an angle, by which the partial beams are tilted with respect to each other, so that the partial beams are deflected accordingly in the course of subdividing the laser beam. The segments may exhibit sharp boundaries to neighboring segments, they also may merge continuously in order to accomplish an individually adapted intensity distribution in the different partial beams.

### BRIEF DESCRIPTION OF THE DRAWINGS

An exemplary embodiment of the invention will be described in more detail below on the basis of the drawings. Shown therein are:

FIG. 1 a schematic representation of a beam path in a laser machining optics in a cross-sectional view and the radiation intensity distribution in the laser beam according to prior art;

FIG. 2 a schematic representation of a beam path in a laser machining optics in a cross-sectional view and the radiation intensity distribution in the laser focus according to the invention;

FIG. 3 a schematic representation of three variants of the laser machining optics in a cross-sectional view according to the invention;

FIG. 4 a schematic representation of the joint and the weld seam of two workpieces at the position of operation in plan view during performing the laser beam joining method according to the invention using two partial beams; and

FIG. 5 a schematic representation of the joint and the weld seam of two workpieces at the position of operation in plan view during performing the laser beam joining method according to the invention using four partial beams.

### DETAILED DESCRIPTION OF THE PREFERRED EMBODIMENTS

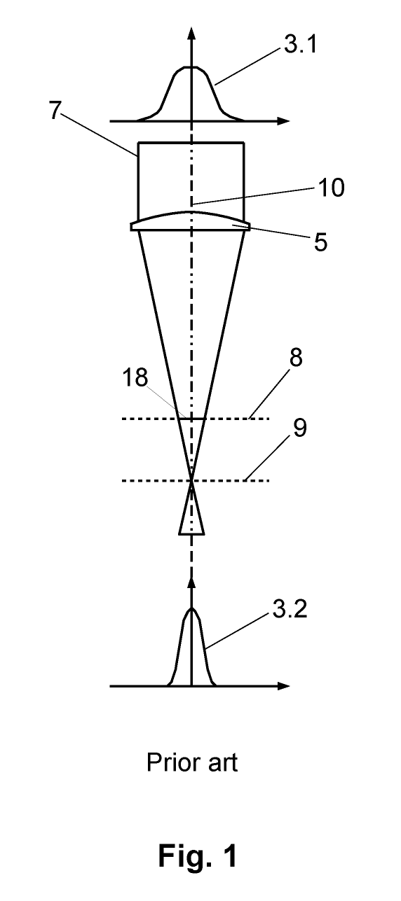

In FIG. 1 a beam path of the laser beam 7 in a laser machining optics according to the prior art is represented. The laser beam 7, which has the Gaussian radiation intensity distribution 3.1 in its cross section, is focused by the focusing device 5 onto the laser focal plane 9, whereby the (defocused) laser focus 18 is formed in the machining plane 8, which in its cross-section shows the radiation intensity distribution 3.2. The maximum of both Gaussian radiation intensity distributions 3.1 and 3.2, respectively, is located on the beam axis 10.

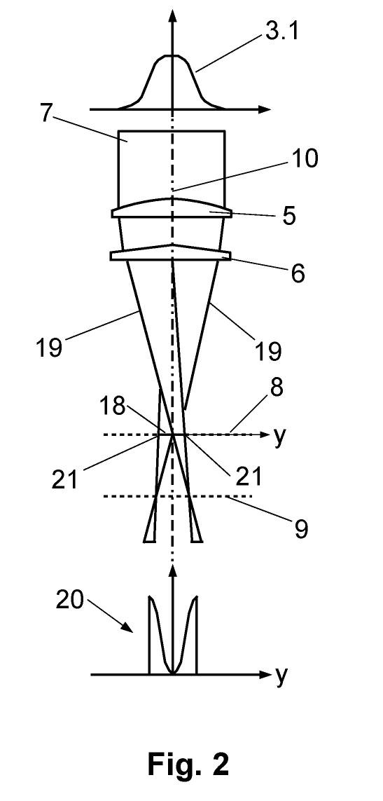

FIG. 2 shows the beam path of the laser beam 7 according to the invention. The laser beam 7, which exhibits the radiation intensity distribution 3.1 in its cross-section, is focused by the focusing device 5 onto the laser focal plane 9 and is subdivided by the beam dividing device 6, here implemented as a roof plate, into two partial beams 19 and deflected in such a way, that the contiguous laser focus 18 is formed in the machining plane 8 by the two partial beams 19. Here, the distance between machining plane 8 and laser focal plane 9 along a beam axis 10 is much larger than the Rayleigh length of the laser beam 7. The radiation intensity distribution 20 of this laser focus 18 along the direction y, as marked in FIG. 2, exhibits in both end regions 21 of the laser focus 18 two sharp maxima, whereas it is decreasing down to zero in the region of the beam axis 10.

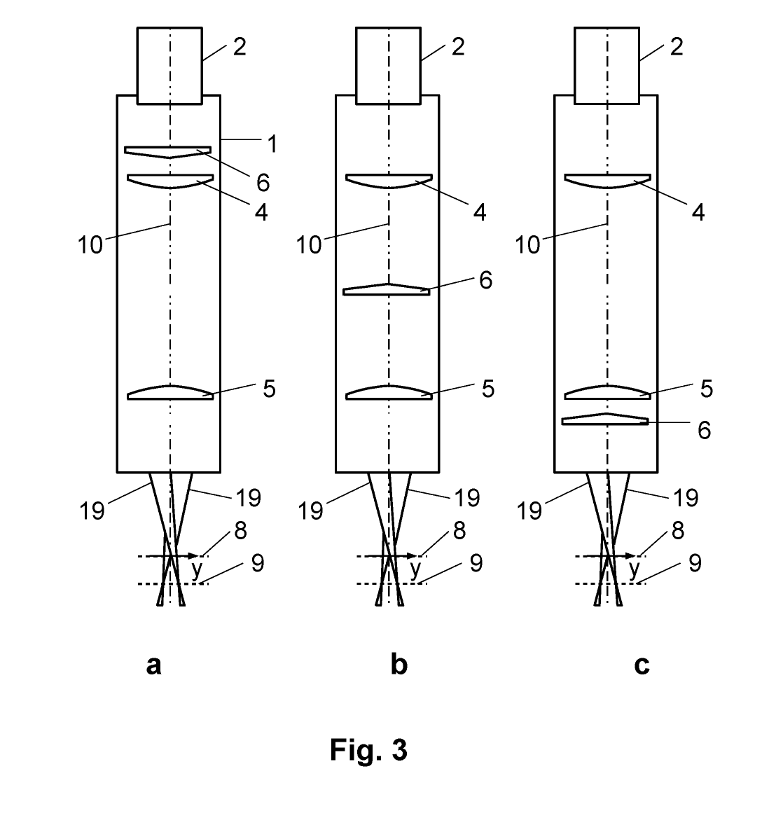

FIG. 3 shows three embodiment variants a, b and c of the laser machining optics according to the invention with respect to the arrangement of the collimation device 4, the focusing device 5 and the beam dividing device 6 along the beam axis 10. The laser beam is coupled into by means of the optical fiber 2.

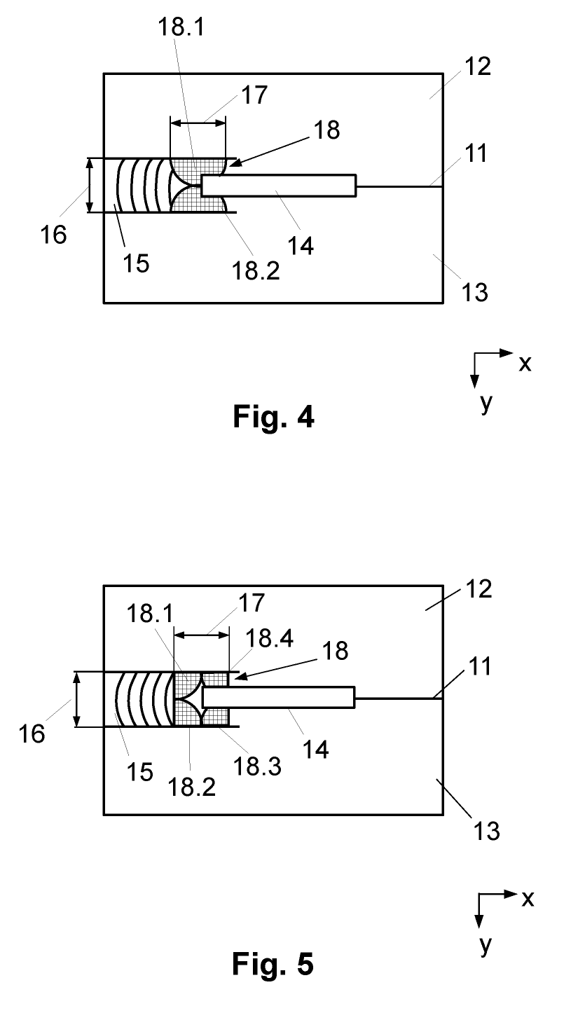

FIG. 4 depicts a top view of the joint 11 and the weld seam 15, respectively, between the two workpieces 12 and 13 during a welding process with additional filler wire according to the laser beam joining method according to the invention. The filler wire 14 is brought upon the joint 11 and molten in the laser focus 18. In this example, the laser beam is divided once into two partial beams, each partial beam forming the partial laser focus 18.1 and 18.2, respectively. The essentially quadratic laser focus 18, which is put together from the two partial beam foci 18.1 and 18.2, is characterized by a length 17 in the feed direction and a width 16 perpendicular to the feed direction. The areas of intense laser irradiation at the two boundaries of the laser focus 18 running parallel to the joint 11, i.e. at the edge regions of the two workpieces 12 and 13 arranged at both sides of the joint 11, are clearly visible along the whole length 17 of the laser focus 18.

In an analogous manner, the plan view of the joint 11 between the two workpieces 12 and 13 during the welding process with additional filler wire according to the laser beam joining method according to the invention when the laser beam is geometrically divided into four partial beams, which are superposed at the weld seam 15 to be created, is shown in FIG. 5. In this case, the laser focus 18, which shows a quadratic shape in the machining plane, is made up of four quadrant-shaped partial laser foci 18.1 to 18.4 of the four partial beams. In this example, the radiation intensity peaks out in each of the four corners of the laser focus 19, whereas it is practically zero in the center of the laser focus 18.

### LIST OF REFERENCE NUMERALS

2 optical fiber
3 radiation intensity distribution
4 collimation device
5 focusing device
6 beam dividing device
7 laser beam
8 machining plane
9 laser focal plane
10 beam axis of the laser beam
11 joint
12 workpiece 1
13 workpiece 2
14 filler wire
15 weld seam
16 width of the seam
17 length of influence of the laser focus
18 laser focus
19 partial beam
20 radiation intensity distribution along the y-direction within the machining plane
21 end region of the laser focus
x feed direction
y direction in the machining plane perpendicular to the feed direction

1. A method for joining a first (12) and a second (13) workpiece using a laser beam (7), characterized in that
the workpieces (12, 13) are positioned such that a joint (11) is formed in-between said workpieces (12, 13) in a machining plane (8)
a laser spot (18) is formed at the joint (11) and at the border regions of the workpieces (12, 13) being located at the joint (11),
wherein following steps are performed:
defocusing the laser beam (7) in the machining plane (8) in a way that the focal point is located in the beam propagation direction downstream of the machining plane (8) at a distance larger than the Rayleigh length;
subdividing the defocused laser beam (7) by means of a beam dividing device (6) into at least two partial beams (19), said partial beams (19) each exhibiting an intensity distribution across its respective partial beam cross section, wherein said subdivision is done in such a way that the at least two partial beams (19) intersect each other in a region located between beam dividing device (6) and machining plane (8), and
superposing the partial beams (19) with an offset from one another to form the laser focus (18) in the machining plane (8), wherein the beam intensity of said laser focus (18) along a line perpendicular to the joint (11) shows maxima in its boundary regions at at least two positions on the two work pieces (12, 13) to be joined, wherein said positions are arranged opposite to each other with respect to the joint (11), as a result of which two regions of high radiation intensity, which are elongated in the feed direction, are formed on the flanks of the joint (11).

2. The method for joining according to claim 1, characterized in that the laser beam (7) is subdivided into two partial beams (19) of equal geometric shape and equal radiation intensity distribution of the partial beam cross sections, wherein a first maximum of the radiation intensity of the laser focus (18) is located on the first workpiece (12) and a second maximum of the radiation intensity is located on the second workpiece (13).

3. The method for joining according to claim 1, characterized in that the laser beam (7) is subdivided into four partial beams (19) of equal geometric shape and equal radiation intensity distribution of the partial beam cross sections, wherein the laser focus (18) exhibits a rectangular shape in the machining plane (8) and wherein each corner of said rectangular laser focus (18) shows a radiation intensity maximum.

4. The method for joining according to claim 1, characterized in that an extension (16) of the laser focus (18) perpendicular to the joint (11), said laser focus being formed by superposing the partial beams (19), equals 50% to 80% of the diameter of the cross section in the machining plane (8) of the undivided laser beam (7).

5. A laser machining optics for performing the method for joining according to claim 1, characterized in that said laser machining optics comprises a collimation device (4), a focusing device (5), which is set up to focus the laser beam (7) at a distance larger than the Rayleigh length downstream of the machining plane (8) with respect of the beam propagation direction, and a beam dividing device (6).

6. The laser machining optics according to claim 5, characterized in that the beam dividing device (6) comprises beam-transmitting elements for subdividing the laser beam (7).

7. The laser machining optics according to claim 5, characterized in that the beam dividing device (6) comprises beam-reflecting elements for subdividing the laser beam (7).

8. The laser machining optics according to claim 5, characterized in that it comprises a scanning unit.

9. The laser machining optics according to claim 5, characterized in that it comprises one or more cylindrical lenses in order to scale the outer dimensions (16, 17) of the laser focus (18).

10. The laser machining optics according to claim 5, characterized in that the focusing device (5) and the beam dividing device (6) are combined in a single optical element, comprising at least one focusing boundary surface between two optical media, said focusing boundary surface being subdivided into a plurality of segments, wherein the respective normal vectors onto the focusing boundary surface of the segments are tilted with respect to each other by an angle of beam deflection.
